(19) United States
(12) Patent Application Publication
(10) Pub. No.: US 2023/0079993 A1
(43) Pub. Date: Mar. 16, 2023

(54) CREATING SERVICES IN A VIRTUALISED NETWORK ENVIRONMENT

(71) Applicant: Telefonaktiebolaget LM Ericsson (publ), Stockholm (SE)

(72) Inventors: Rajavarma BHYRRAJU, Athlone (IE); Madhusudhan BANNUR, Athlone (IE); Cristina BADULESCU, Roxboro Quebec (CA); Arturo Martin DE NICOLAS, Brussels (BE); Umakanth SRINIVASAN, Athlone (IE)

(21) Appl. No.: 17/798,697

(22) PCT Filed: Jan. 22, 2021
(86) PCT No.: PCT/EP2021/051508

§ 371 Date: Aug. 10, 2022

Related U.S. Application Data
(60) Provisional application No. 62/972,690, filed on Feb. 11, 2020.

(51) Int. Cl. H04L 41/5041; H04L 41/40

(52) U.S. Cl. CPC H04L 41/5041; H04L 41/40

(57) ABSTRACT

A method at an orchestrator in a virtualized environment of a communications network. The method comprises receiving a request related to operation of a service, wherein the request comprises a first attribute instructing the orchestrator to perform a feasibility check for the service identified in said request. The method further comprises performing the feasibility check for the service and responding to the request based on the result of the feasibility check.

### TECHNICAL FIELD

The present disclosure relates to virtualised networks, in general, and in particular to creating services in a virtualised network environment.

### BACKGROUND

When services involve dependencies on physical resources, their availability is verified based on the data from inventory system and based on the policy, resources can be reserved for the execution of the service.

In case of handling services involving virtual resources, the resources are created and instantiated during the service process time. The service may involve allocation of resources from different domains, potentially across different locations and any related connectivity between the sites. Hence service is realized by combining different network services across different resource orchestrators. Creation or update of network services on different domains can be done in parallel. Today, handling of services is reactive and is deemed successful when all dependent services are created. In case of any failures, roll back actions have to be performed and required problem mitigation actions have to be done before retrying the service processing.

Using ETSI GS NFV-SOL005 v.3.3.1 standard as example, the NFVO, upon receiving a network Service Instantiation Request, performs the required processing and forwards the request to the applicable VNFM's to create and instantiate the VNF instances that are part of that network service instance. During the instantiation of the constituent elements of NS such as VNF, VL etc., VNFM will reach out to NFVO for resource approval (via Grant requests).

In this document, the term service is used in a generic sense, covering services created by network operators at any orchestration levels (e.g. E2E services, Communication Services (in 3GPP SA5 definition), Network Services (in ETSI NFV definition), etc).

Today, the only way to determine if a service execution (service creation, service update, etc.) can be successful, is to actually prepare the full service (e.g. for a service creation and instantiation it means to actually create and instantiate the service) and roll back if it fails. For a future dated service execution (service creation, service update, etc.) the failure is observed only at the time of actual execution of the service. Upon a failure, the time to mitigate the resource constraints is limited.

With the current lack of feasibility checks and reservation, the system behaviour is reactive and poses a risk of failure in service processing. If any of the constituent elements of NS (network service) cannot be instantiated due to resource constraints, the network service instantiation operation fails. Due to failure in any of the domains, the complete service creation fails and roll back is required to release the resources. In case of a service involving multiple domains and/or multiple resource orchestrators, the overall overhead of roll back is complex. There is no opportunity to perform resource shortage mitigation for the specific service without rolling back of any nested services that were already created for realizing the service. The rollback is an undesirable process from the network operators' perspective, as it bears operational and technical implications on both the network and the planning staff that requested the failed service.

### SUMMARY

The disclosed solution provides a method that offers a feasibility check for a service to be instantiated, at a given date and time (immediate or in the future). Such feasibility check will help the network operators to provide them with an assessment if the needed infrastructure resources are available in the network at the requested date and time. Such an assessment is beneficial before executing the service because any issue with insufficient infrastructure resources for the service creation or update which requires additional resources (e.g. added VNF instances, VLs, changing the service deployment flavour for more resources, etc.) has the consequence of mandating a rollback of the service. Rollbacks are undesirable and have significant operational consequences, so in most situations they should be avoided.

Based on the service, the respective operation may require allocation of resources from different infrastructure domains across different locations, including the related connectivity between the sites. The feasibility check involves assessment of resource availability across all these needed resources to fulfil the service at the requested date and time. Optionally, reserving resources (e.g. via the Virtualized Resources Reservation Management interface defined in ETSI NFV-IFA005/Or-Vi) and scheduling the instantiation at a specific date and time is also possible after the feasibility check is successful.

According to a first aspect of the disclosed solution there is provided a method at an orchestrator in a virtualised environment of a communications network. The method comprises receiving a request related to operation of a service. The request comprises a first attribute instructing the orchestrator to perform a feasibility check for the service identified in said request. The method also comprises performing the feasibility check for the service and responding to the request based on the result of the feasibility check.

According to a second aspect of the disclosed solution there is provided a method at an entity in a virtualised environment of a communications network. The method comprises sending to an orchestrator a request related to operation of a service, wherein the request comprises a first attribute instructing the orchestrator to perform a feasibility check for the service identified in said request.

According to a third aspect of the disclosed solution there is provided a computer program comprising instructions which, when executed on at least one processor, cause the at least one processor to carry out a method according to embodiments disclosed in this document.

According to a fourth aspect of the disclosed solution there is provided a carrier containing a computer program disclosed earlier, wherein the carrier comprises one of an electronic signal, optical signal, radio signal or computer readable storage medium.

According to a fifth aspect of the disclosed solution there is provided a computer program product comprising non transitory computer readable media having stored thereon a computer program disclosed earlier.

According to a sixth aspect of the disclosed solution there is provided a first network element for implementing an orchestrator. The first network element comprising a processing circuitry and a memory. The memory contains instructions executable by the processing circuitry such that the first network element is operative to receive a request related to operation of a service. The request comprises a first attribute instructing the orchestrator to perform a feasibility check for the service identified in said request. The first network element is also operative to perform the feasibility check for the service and to respond to the request based on the result of the feasibility check.

According to a seventh aspect of the disclosed solution there is provided a second network element for implementing an entity in a virtualised environment of a communications network. The second network element comprises a processing circuitry and a memory. The memory contains instructions executable by the processing circuitry such that the second network element is operative to send to an orchestrator a request related to operation of a service, wherein the request comprises a first attribute instructing the orchestrator to perform a feasibility check for the service identified in said request.

According to a seventh aspect of the disclosed solution there is provided a network comprising a first network element and a second network element both network elements according to embodiments disclosed in this document. The first network element and the second network element are operative to perform the methods according to any one of the embodiments disclosed in this document.

The disclosed solution provides the following advantages:

Reliability: augmenting the existing flows for the service instantiation and update with feasibility checks provides an opportunity to mitigate the resource availability problems before instantiating the network service. Subject to the operator's policy, the required resources for the network service can also be reserved at the feasibility check time to ensure the future service instantiation will not fail due to unavailability of resources.

Agility: by augmenting the existing standard based interfaces exposed by NFVO over Os-Ma interface the time to implement the proposed feasibility check and reserve flows by products which already comply to this standard will be significantly faster. Alternatively, this can also be solved by proposing new operations dedicated to the feasibility checks, but this option would require additional information exchange for the feasibility check for the intended operation and then sending the operation with the same data to actually instantiate or update. This includes change in existing execution flows, implementation and verification effort.

Testability and Automation: The automations for instantiate flows known from the existing standard documents can be extended to this newly proposed feasibility check and resource reservation functionality.

### BRIEF DESCRIPTION OF THE DRAWINGS

The disclosed solution will be understood and appreciated more fully from the following detailed description taken in conjunction with the drawings in which:

FIG. 1-FIG. 8 are charts illustrating examples of operation of a method in several embodiments;

FIG. 9 is a diagram illustrating a first network element in one embodiment;

FIG. 10 is a diagram illustrating a second network element in one embodiment;

FIG. 11 is a diagram illustrating a virtual network environment managed by an NFV MANO, system.

### DETAILED DESCRIPTION

In the following description, for purposes of explanation and not limitation, specific details are set forth such as particular architectures, interfaces, techniques, etc. in order to provide a thorough understanding of the disclosed solution. However, it will be apparent to those skilled in the art that the disclosed solution may be practiced in other embodiments that depart from these specific details. In other instances, detailed descriptions of well-known devices, circuits, and methods are omitted so as not to obscure the description of the disclosed solution with unnecessary details.

Reference throughout the specification to “one embodiment” or “an embodiment” means that a particular feature, structure, or characteristic described in connection with an embodiment is included in at least one embodiment of the disclosed solution. Thus, the appearance of the phrases “in one embodiment” or “in an embodiment” in various places throughout the specification are not necessarily all referring to the same embodiment. Further, the particular features, structures or characteristics may be combined in any suitable manner in one or more embodiments.

The disclosed solution aims at enhancing the handling of services involving network functions by adding feasibility check and, optionally, resource reservation ahead of time. In essence, in the disclosed solution, for a request to instantiate a service or to update a service (immediately or scheduled for the future) the NFVO shall perform a feasibility check and optionally support resource reservation before instantiating or updating the service.

It is desirable to be able to perform service capability checks, reserve the needed resource(s), be able to mitigate the resource shortage issues independently and have the ability to retry the service instantiations or updates in case of failures. Such mitigation of resource shortage situations may also imply pre-emptive actions on resources already allocated to or reserved for other services which have a lower priority, and/or actions performed in conjunction with operator's policies. The end to end service feasibility and reservation functionality includes checking feasibility and reservation of all required components to fulfil the service which include required VNFs, VLs, connectivity within the site and MSCS etc.

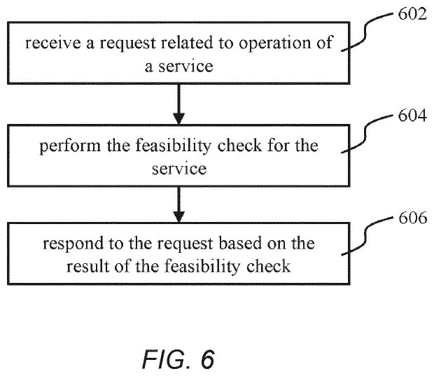

With reference to FIG. 6 one embodiment of a method at an orchestrator in a virtualised environment of a communications network is now to be disclosed. The method comprises receiving, 602, a request related to operation of a service, wherein the request comprises a first attribute instructing the orchestrator to perform a feasibility check for the service identified in said request. In the following step the method comprises performing, 604, the feasibility check for the service and then responding, 606, to the request based on the result of the feasibility check.

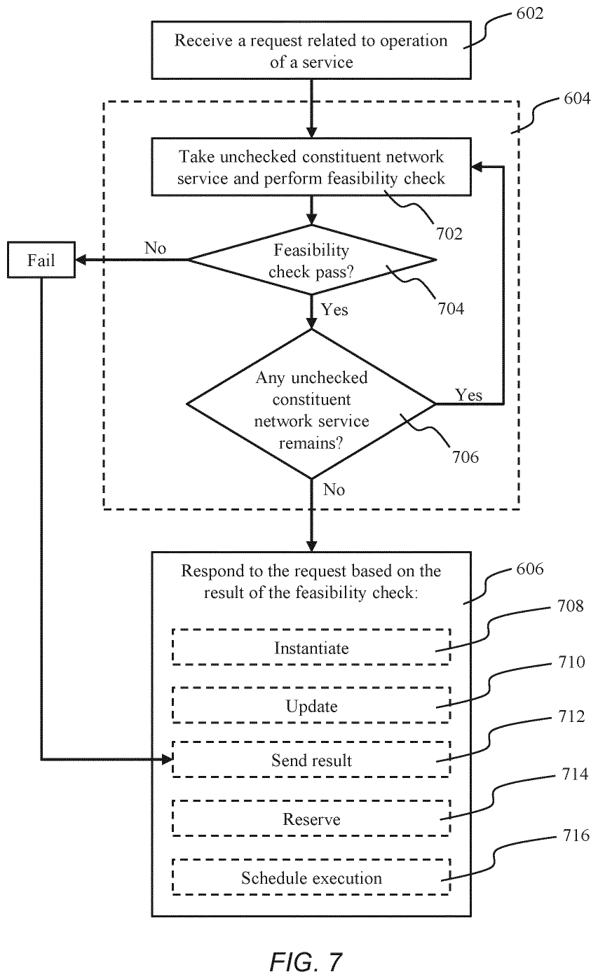

More details related to various embodiments of this method are illustrated in FIG. 7.

Preferably, said request related to operation of the service comprises a second attribute instructing the orchestrator to perform reservation, 714, of resources required for the service identified in said request.

Preferably, said feasibility check, 604, is performed for constituent network services of said service. This is illustrated by the loop 702-706, in FIG. 7, which continues until all constituent network services are checked for feasibility, 704-Yes-706-No, or until a first of the constituent network services fails the feasibility check, 704-No.

Preferably said reservation, 714, starts at time specified in said request related to operation of the service.

In a preferred embodiment, responding to said request related to operation of the service comprises sending a result, 712, of the feasibility check to an entity from which said request related to operation of the service was received.

In a preferred embodiment, responding to said request related to operation of the service comprises performing the operation, 708, 710, identified in said request if said feasibility check resulted in a pass 704-Yes-706-No.

In a preferred embodiment, performing the operation identified in said request starts at time specified in said request related to operation of the service.

Preferably, the method comprises sending a result, 712, of the feasibility check to the entity from which said request related to operation of the service was received.

Preferably, responding to said request related to operation of the service comprises performing reservation, 714, of resources required for the service identified in said request and scheduling execution, 716, of the operation, 708, 710, identified in said request if said feasibility check resulted in a pass.

Preferably, the method further comprises sending a result, 712, of the feasibility check to the entity from which said request related to operation of the service was received.

Preferably, the feasibility check for the service identified in said request fails if at least one of the constituent network services of said service fails the feasibility check, 704-No.

Preferably, said request related to operation of the service comprises a request to instantiate, 708, the service.

Preferably, said request related to operation of the service comprises a request to update, 710, the service.

In a preferred embodiment said orchestrator comprises a Network Functions Virtualization Orchestrator.

With reference to FIG. 8 one embodiment of a method at an entity in a virtualised environment of a communications network is now to be disclosed. The method comprises sending, 802, to an orchestrator a request related to operation of a service. The request comprises a first attribute instructing the orchestrator to perform a feasibility check for the service identified in said request. Preferably, said request related to operation of the service comprises a second attribute instructing the orchestrator to perform reservation of resources required for the service identified in said request.

As explained in the description of embodiments on the method operating at the orchestrator said feasibility check is to be performed for constituent network services of said service. Preferably, said reservation starts at time specified in said request related to operation of the service.

In a referred embodiment the method comprises receiving, 804, a result of the feasibility check.

Said request related to operation of the service may comprise an instruction to perform the operation identified in said request if said feasibility check results in a pass.

Said request related to operation of the service may comprises an instruction to start performing the operation identified in said request at time specified in the said request.

Said request related to operation of the service may comprise an instruction to perform reservation of resources required for the service identified in said request and to schedule execution of the operation identified in said request if said feasibility check resulted in a pass.

Preferably, the method may further comprise receiving, 804, a result of the feasibility check.

Preferably, the request related to operation of the service comprises a request to instantiate the service.

Preferably, the request related to operation of the service comprises a request to update the service.

In embodiments of the method said entity may comprise one of a service orchestrator, an Network Functions Virtualization Orchestrator, Operation Support System or Business Support System.

Further details of the embodiments of the methods disclosed.

In ETSI NFV MANO, network service instantiation and update operations are standardized and explained in ETSI NFV-IFA013 and ETSI NFV-SOL005 standards. The service instantiation and update requests have option to process at a scheduled time. How to react to failures and how to handle the end to end service are outside the ETSI MANO standardization. Handling of services combines feasibility checks and reservation for all network services needed for the service (i.e. the service to be delivered to a consumer of the service may be an aggregation of two or more network services).

Feasibility checks provide functionality to verify the current resource situation. But it is not always guaranteed that the service which was successful at the feasibility check time will be successful at the scheduled future time when the service needs to be executed. The infrastructure resources available today may not be available in the future as they might have been used by some other service. This leads to the current proposal on feasibility checks combined with reservation of resources. With these additions, the processing of a service involving virtual network resources will be almost in line with physical resources and will give a better guarantee to the operator on the success of the future execution of the service creation or modification.

The network service (NS) feasibility checks may use the resource availability information at the resource orchestrators (NFVO) or to use query operations to find the latest availability of the virtual resources, for example, by querying the VIM for resource availability if this information is not available at the NFVO. The resource availability is maintained at the NFVO, but if there is any issue with the resource sync or the NFVO needs latest information then the NFVO can query the VIM. Feasibility check indicates the feasibility of network service based on the known availability of all needed resources for the scheduled time of the service (based on current availability and scheduled services with reservations). The scheduled instantiation is supported based on a startTime attribute (or a corresponding attribute with a different name) in the service Instantiate Request and scheduled update is supported based on an updateTime attribute (or a corresponding attribute with a different name) in the Service Update Request. The feasibility of all constituent (nested) network services may be processed in parallel (or serially, one after another) and the reservation mechanism can be done prior to starting the instantiation process at a scheduled time. The description of embodiments in this document refers to instantiation of individual constituent services of the network service (NS), which may also be described as an end-to-end service and refers creation of the network service.

The reservation functionality may be realised by reserving the required resources before the scheduled service execution time, coordinating this reservation with the resource orchestrators. In case of ETSI NFV, the resource reservation may be performed based on modifications proposed in ETSI GS NFV-IFA013 and/or ETSI GS NFV-SOL005 interfaces, to send the information between OSS/BSS and NFVO.

Table 1 below explains various use cases where an NFVO receives a Service Instantiate Request or a Service Update Request and the NFVO operates according to the method disclosed in this document. The method disclosed in this document is based on existing Service Instantiate and Service Update Requests and is backward compatible, which means that if some (or all) elements and functions in the network do not support the disclosed solution the NFVO will handle respective Service Instantiate and Service Update Requests from these elements and functions in the same way as it is done in prior art today, i.e. without feasibility check and without reservation of resources. This is the first use case described in Table 1.

TABLE 1

| | Input Options | | | |
|---|---|---|---|---|
| | | | Reserva- | |
| | | | tion | Behavior expected when the disclosed |
| Use case | Schedule time set | Feasibility Check | Required | solution is implemented |
| Service Instantiation/ | Set to scheduled | NO_FEASIBILITY_CHECK | FALSE | The Service instantiation/update happens |
| Update (Immediate/ | date/time for | | | (immediate/scheduled) without any |
| Scheduled) without | scheduled operation. | | | feasibility check or reservation. |
| feasibility check and | Not set for | | | (Default behavior without new options) |
| without reservation | immediate opera- | | | |
| | tion. | | | |
| Service feasibility | Not set. | FEASIBILITY_CHECK_ONLY | FALSE | Feasibility Check is performed for the |
| check only | | | | constituent network services of the Service |
| | | | | for the specified operation at the current |
| | | | | time. |
| | | | | In case of Feasibility check successful, the |
| | | | | details are sent in additionalParameters |
| | | | | in the NsLcmOperationOccurrence- |
| | | | | Notification notifying the result. |
| | | | | In case of Feasibility check failure, error |
| | | | | is sent in the |
| | | | | NsLcmOperationOccurrenceNotification |
| | | | | notifying the failure. |
| Service Instantiation/ | Set to scheduled | FEASIBILITY_CHECK_WITH_OPERATION | FALSE | Feasibility Check is performed for all the |
| Update (Immediate/ | date/time for | | | constituent network services of the Service |
| Scheduled) with | scheduled opera- | | | at the time of Service processing (at |
| feasibility check | tion. | | | current time for immediate operation and |
| without reservation | Not set for | | | at scheduled time for scheduled opera- |
| | immediate opera- | | | tion). |
| | tion. | | | Feasibility check result for each |
| | | | | constituent NS, will be sent in the |
| | | | | NsLcmOperationOccurrenceNotification. |
| | | | | Only when feasibility check for the |
| | | | | network service is successful, operation |
| | | | | (Service Instantiation/Service Update) is |
| | | | | scheduled or immediate. |
| | | | | In case of Feasibility check failure for |
| | | | | one or more constituent NSs, the overall |
| | | | | feasibility for Service will be marked |
| | | | | as Fail. |
| Scheduled Service | Set to | FEASIBILITY_CHECK_WITH_OPERATION | TRUE | Feasibility Check for all the constituent |
| Instantiation/ | scheduled | | | network services of the Service is |
| Update with | date/time. | | | performed based on current resource |
| reservation | | | | availability and known scheduled services |
| | | | | with reservations. |
| | | | | Feasibility check result for each |
| | | | | constituent NS, may be sent in the |
| | | | | NsLcmOperationOccurrenceNotification. |
| | | | | Only when feasibility check is successful, |
| | | | | resources are reserved for the schedule |
| | | | | time of the operation (NS Instantiation/ |
| | | | | NS Update). Based on policies the |
| | | | | reservation may start immediately or |
| | | | | before schedule starting time. |
| | | | | In case of Feasibility check failure for |
| | | | | one or more constituent NSs, the overall |
| | | | | Service scheduling will be marked as Fail. |
| | | | | Based on the resource mitigation possible |
| | | | | and operator policy, the Service |
| | | | | scheduling may continue for partial |
| | | | | failures. The failed nested NSs can be |
| | | | | retried or updated at a later time without |
| | | | | cancelling the reservations of other NSs. |

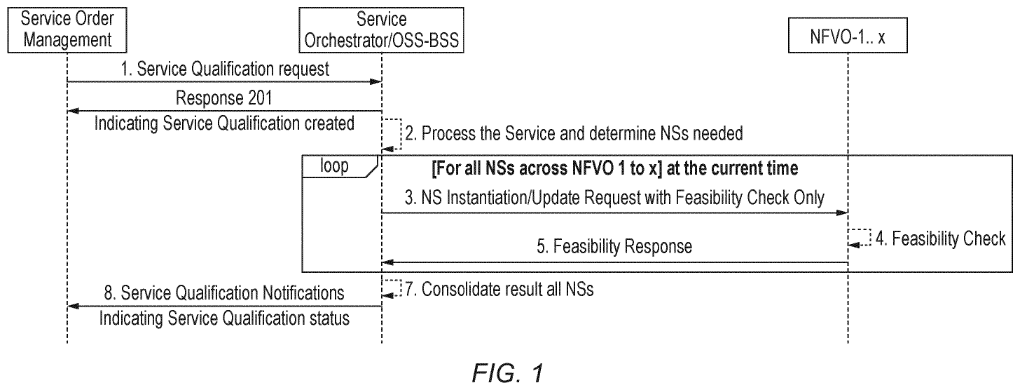

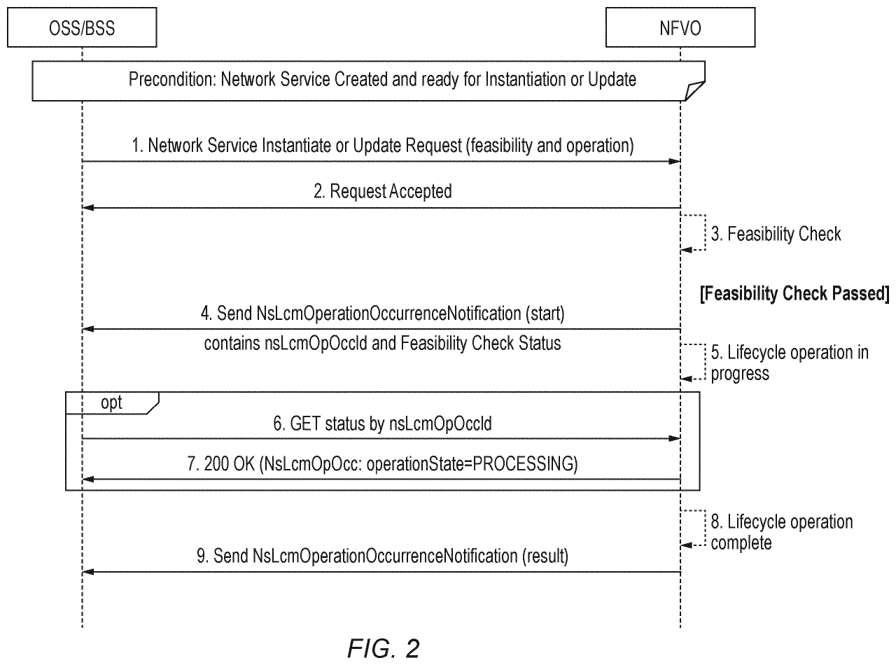

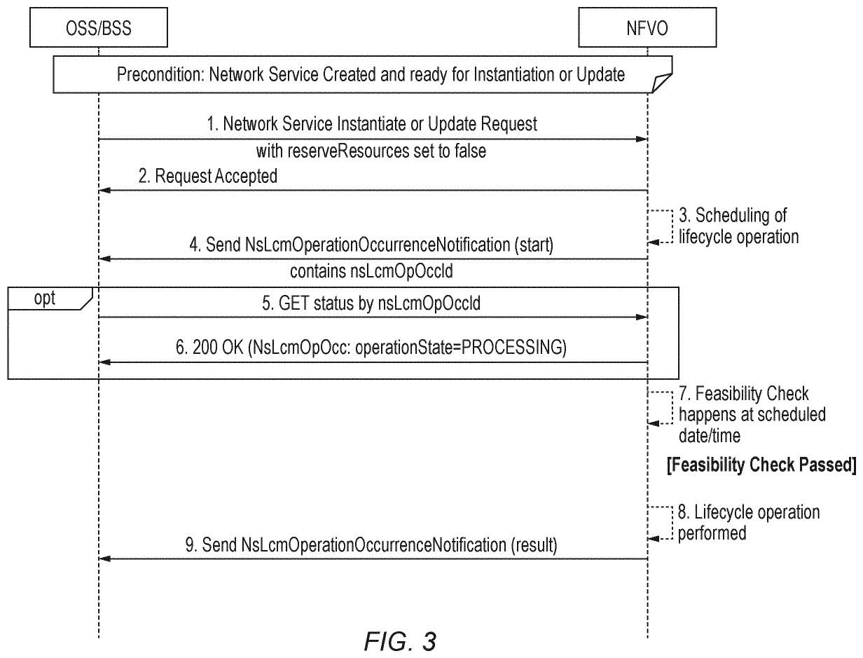

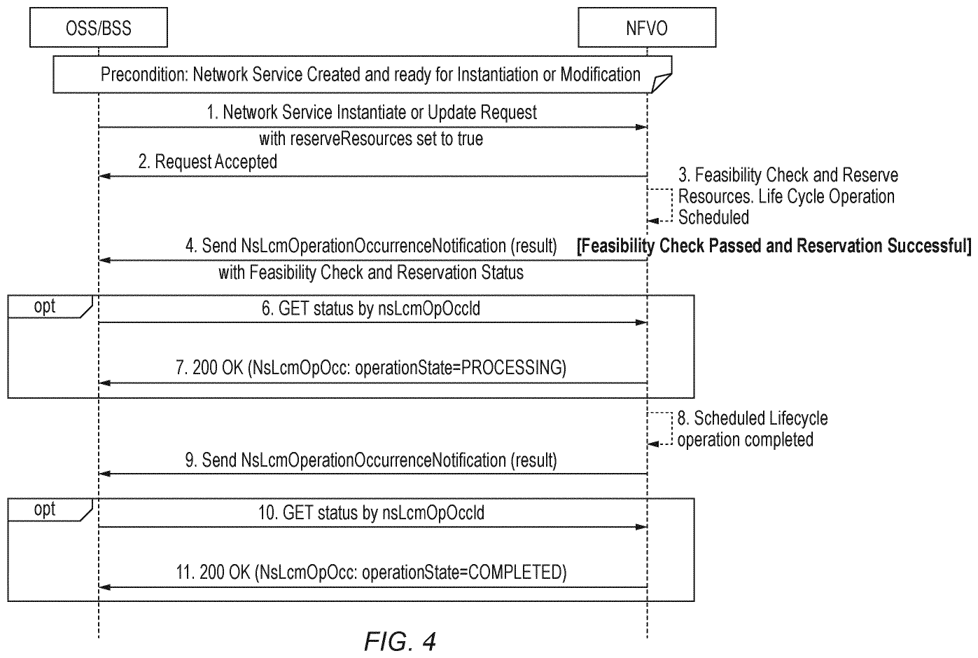

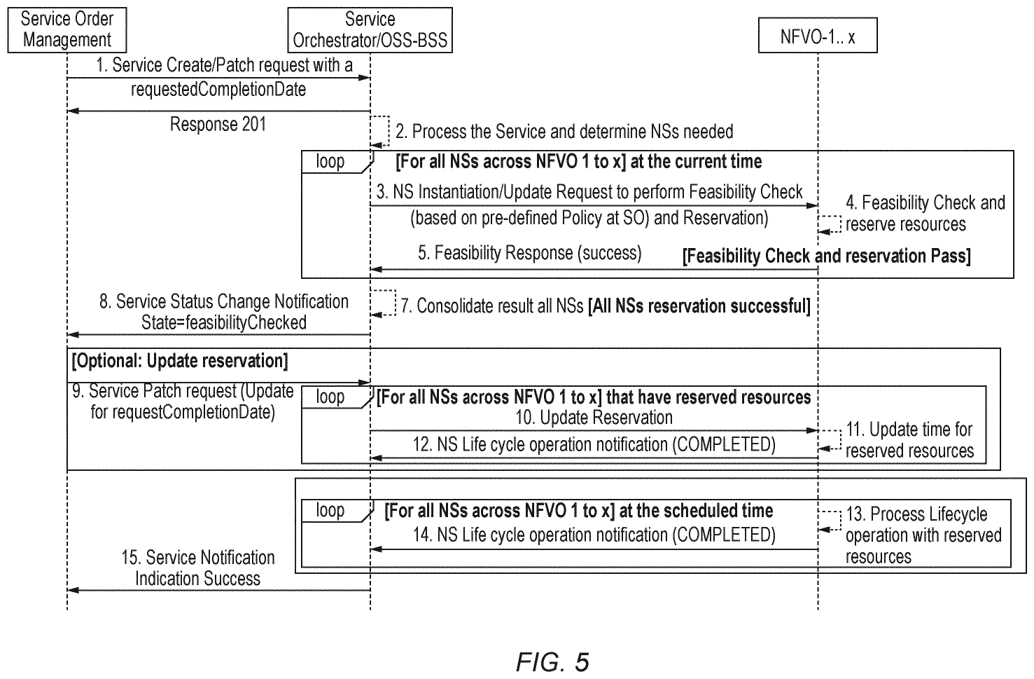

The use cases listed in Table 1 would operate in a network implementing the method disclosed in this document. The following provides brief description of the use cases.
1. Service Instantiation/Update (Immediate or Scheduled) without feasibility check and without reservation (backward compatibility without the functionality).
   Service Instantiation/Update for each constituent NS (network service) is performed without feasibility check and without reservation by setting the following attributes:
      Schedule time (startTime/updateTime) is not set for immediate operation. Set to scheduled start time or update time for scheduled operation.
      feasibilityCheck is set to “NO_FEASIBILITY_CHECK”.
      reserveResources is not set or set to “FALSE”.
   No feasibility check or reservation will be performed. Ensures backward compatibility.
2. Service Feasibility Check only, as illustrated in FIG. 1.
   Feasibility check for each constituent NS is done at the current time by setting the following attributes:
      Schedule time (startTime/updateTime) is not set.
      feasibilityCheck is set to “FEASIBILITY_CHECK_ONLY”.
      reserveResources is not set or set to “FALSE”.
      Feasibility check is done for each NS at the current time.
      No additional operation is done after the feasibility check.
   Feasibility for Service is consolidated based on the response received for all constituent NSs.
3. Service Instantiation/Service Update (Immediate or Scheduled) with feasibility check without reservation, as illustrated in FIG. 2 (for immediate) and in FIG. 3 (for Scheduled).
   Feasibility check for each constituent NS is done followed by the operation (Service Instantiation or Service Update) without resource reservation by setting the following attributes:
      Schedule time (startTime/updateTime) is not set for immediate processing. Set to scheduled start time or update time for scheduled operation.
      feasibilityCheck is set to
      “FEASIBILITY_CHECK_WITH_OPERATION”.
      reserveResources is not set or set to “FALSE”, to specify no reservation is needed.
      Feasibility check is done at the at the processing time (current time for immediate process and at scheduled time for scheduled operation).
   Feasibility for Service is consolidated based on the response received for all constituent NSs.
      Upon checking the feasibility for Service, required operation is performed for each constituent NS.
4. Schedule Service Instantiation/Service Update for a future date and time with reservation, as illustrated in FIG. 4. FIG. 5 is for the same flow as illustrated in FIG. 4 but giving an end to end view from the service perspective.
   Feasibility check for each constituent NS is done and resources will be reserved by setting the following attributes:
      Schedule Time (startTime/updateTime) for the operation is set to the date/time for service process time.
      feasibilityCheck is set to
      “FEASIBILITY_CHECK_WITH_OPERATION” to specify feasibility check is required for this scheduled operation.
      reserveResources is not set or set to “True” to specify reservation is required for the service.
      Feasibility check for each constituent NS is done at the current time.
      Resources are marked reserved for the scheduled time of the operation (instantiation or update).
   At the scheduled time, for each constituent NS, Service operation is processed with the reserved resources.

In order support feasibility check and reservation disclosed in this document changes may be necessary to ETSI GS NFV-IFA013 and ETSI GS NFV-SOL005 standard specifications. As presented in Table 2 the InstantiateNsRequest in one embodiment may be updated by addition of two new attributes: feasibilityCheck and reserveResources. The actual names of the attributes in a revised version of the standard may be different. ETSI GS NFV-IFA013 is stage-2 whereas ETSI GS NFV-SOL005 is stage-3. The message type definitions in model are defined IFA013 and the changes proposed here are needed in both stage-2 and stage-3 standard specifications. ETSI GS NFV-IFA013 specifies the Interface and Information Model Specification of Os-Ma-Nfvo reference point and ETSI GS NFV-SOL005 specifies RESTful protocols specification for the Os-Ma-nfvo Reference Point. Stage-2 contains the data types and operations and the APIs to realize these operations are defined in stage-3.

The attribute feasibilityCheck identifies the options available for defining for the operation of checking feasibility. In one embodiment the permitted values may include:
NO_FEASIBILITY_CHECK, which indicates that the feasibility check is not required. This may be the default option that ensures backward compatibility.
FEASIBILITY_CHECK_WITH_OPERATION, which indicates that the feasibility check shall be performed, and instantiation operation is done (or not done) based on the result of the feasibility check.

Additionally, the permitted values of the feasibilityCheck attribute may include:
FEASIBILITY_CHECK_ONLY, which indicates that only feasibility check is required, and no instantiation operation is done after feasibility check. This is to be used only to check feasibility and the consumer of the feasibility check response may or may not do anything after receiving the result.

The attribute reserveResources may have only one of two permitted values: True or False. It is set to True if resource reservation must be done. The resource is marked reserved based on the Timestamp value set in startTime attribute. It is set to False if resource reservation is not needed.

More details about the new attributes can be found in Table 2 below.

The remaining attributes of the InstantiateNsRequest remain as defined in the ETSI GS NFV-SOL005.

TABLE 2
Type: InstantiateNsRequest, with support to perform feasibility check and reservation

| Attribute Name | Data type | Cardinality | Description |
|---|---|---|---|
| nsFlavourId | IdentifierInNsd | 1 | Identifier of the NS deployment flavor for which |
| | | | Instantiation/Feasibility check/Reservation has to be |
| | | | performed |
| sapData | SapData | 0 . . . N | Create data concerning the SAPs of this NS. |
| addpnfData | AddPnfData | 0 . . . N | Information on the PNF(s) that are part of this NS. |
| vnfInstanceData | VnfInstanceData | 0 . . . N | Specify an existing VNF instance to be used in the NS. |
| | | | If needed, the VNF Profile to be used for this VNF instance is |
| | | | also provided. |
| nestedNsInstanceId | Identifier | 0 . . . N | Specify an existing NS instance to be used as a nested NS |
| | | | within the NS. |
| localizationLanguage | VnfLocationConstraint | 0 . . . N | Defines the location constraints for the VNF to be instantiated |
| | | | as part of the NS instantiation/feasibility check/reservation. |
| | | | An example can be a constraint for the VNF to be in a |
| | | | specific geographic location. |
| additionalParamsForNs | KeyValuePairs | 0 . . . 1 | Allows the OSS/BSS to provide additional parameter(s) |
| | | | at the NS level (as opposed to the VNF level, which is |
| | | | covered in additionalParamsForVnf). |
| additionalParamsForVnf | ParamsForVnf | 0 . . . N | Allows the OSS/BSS to provide additional parameter(s) per |
| | | | VNF instance (as opposed to the NS level, which is covered |
| | | | in additionalParamsForNs). This is for VNFs that are to be |
| | | | created by the NFVO as part of the NS |
| | | | instantiation/feasibility check/reservation and not for existing |
| | | | VNF that are referenced for reuse. |
| startTime | DateTime | 0 . . . 1 | Timestamp indicating the earliest time to instantiate the |
| | | | NS. Cardinality “0” indicates the NS instantiation takes place |
| | | | immediately. |
| nsInstantiationLevelId | IdentifierInNsd | 0 . . . 1 | Identifies one of the NS instantiation levels declared in the |
| | | | DF applicable to this NS instance. If not present, the default |
| | | | NS instantiation level as declared in the NSD shall be used. |
| additionalAffinityOrAntiAffinityRule | AffinityOrAntiAffinityRule | 0 . . . N | Specifies additional affinity or anti-affinity constraint for the |
| | | | VNF instances to be instantiated as part of the NS |
| | | | instantiation/feasibility check/reservation. Shall not conflict |
| | | | with rules already specified in the NSD. |
| feasibilityCheck | Enum (inlined) | 0 . . . 1 | Identifies the feasibility check related options with the |
| | | | operation. |
| | | | Permitted values: |
| | | | NO_FEASIBILITY_CHECK = Feasibility check |
| | | | not required. Default option. |
| | | | FEASIBILITY_CHECK_ONLY = Only |
| | | | feasibility check is required. No instantiation |
| | | | operation is done after feasibility check. |
| | | | FEASIBILITY_CHECK_WITH_OPERATION = |
| | | | Feasibility check performed, and instantiation |
| | | | operation is done based on result of feasibility |
| | | | check. |
| reserveResources | Boolean | 0 . . . 1 | Set to “True” if resource reservation must be done. The |
| | | | resource is marked reserved based on the Timestamp value set |
| | | | in startTime attribute. |
| | | | Set to “FALSE” if resource reservation is not needed. |

Notes to table 2:
When only feasibility check is required for the operation, or when no feasibility check is required, the reserveResources attribute shall be ignored.
When there is no startTime indicated, i.e. immediate instantiation, the reserveResources attribute shall be ignored.

As presented in Table 3 below also the UpdateNsRequest in one embodiment may be updated by addition of two new attributes: feasibilityCheck and reserveResources. The actual names of the attributes in a revised version of the standard may be different. The operation and permitted values of the two new attributes of the UpdateNsRequest in a preferred embodiment may be the same as for the corresponding attributes of the InstantiateNsRequest as described above.

More details about the new attributes can be found in Table 3 below.

The remaining attributes of the UpdateNsRequest remain as defined in the ETSI GS NFV-SOL005. For brevity, Table 3 below reproduces only two other attributes of the UpdateNsRequest, the rest can be found in the identified standard specification.

TABLE 3
Type: UpdateNsRequest, with support to perform feasibility check and reservation

| Attribute Name | Data type | Cardinality | Description |
|---|---|---|---|
| updateType | Enum (inlined) | 1 | The type of update. It determines also which one of the |
| | | | following parameters is present in the operation. |
| | | | Possible values include: |
| | | | ADD_VNF: Adding existing VNF instance(s) |
| | | | REMOVE_VNF: Removing VNF instance(s) |
| | | | INSTANTIATE_VNF: Instantiating new VNF(s) |
| | | | CHANGE_VNF_DF: Changing VNF DF |
| | | | OPERATE_VNF: Changing VNF state, |
| | | | MODIFY_VNF_INFORMATION: Modifying |
| | | | VNF information and/or the configurable |
| | | | properties of VNF instance(s) |
| | | | CHANGE_EXTERNAL_VNF_CONNECTIVITY: |
| | | | Changing the external connectivity of VNF |
| | | | instance(s) |
| | | | ADD_SAP: Adding SAP(s) |
| | | | REMOVE_SAP: Removing SAP(s) |
| | | | ADD_NESTED_NS: Adding existing NS |
| | | | instance(s) as nested NS(s) |
| | | | REMOVE_NESTED_NS: Removing existing |
| | | | nested NS instance(s) |
| | | | ASSOC_NEW_NSD_VERSION: Associating a |
| | | | new NSD version to the NS instance |
| | | | MOVE_VNF: Moving VNF instance(s) from one |
| | | | origin NS instance to another target NS |
| | | | instance |
| | | | ADD_VNFFG: Adding VNFFG(s) |
| | | | REMOVE_VNFFG: Removing VNFFG(s) |
| | | | UPDATE_VNFFG: Updating VNFFG(s) |
| | | | CHANGE_NS_DF: Changing NS DF |
| | | | ADD_PNF: Adding PNF |
| | | | MODIFY_PNF: Modifying PNF |
| | | | REMOVE_PNF: Removing PNF |
| | | | Feasibility check/Reservation is applicable only for relevant updateTypes' |
| updateTime | DateTime | 0 . . . 1 | Timestamp indicating the update time of the NS, i.e. the NS will be updated |
| | | | at this timestamp. Cardinality “0” indicates the NS update takes place |
| | | | immediately. |

All other fields as mentioned in UpdateNSRequest of NS Management Interface defined in ETSI GS NFV-SOL005 Specification

| | | | |
|---|---|---|---|
| feasibilityCheck | Enum | 0 . . . 1 | Identifies the feasibility check related options with update operation. |
| | (inlined) | | Permitted values: |
| | | | NO_FEASIBILITY_CHECK = Feasibility check not required. |
| | | | Default option. |
| | | | FEASIBILITY_CHECK_ONLY = Only feasibility check is |
| | | | required. No update operation is done after feasibility check. |
| | | | FEASIBILITY_CHECK_WITH_OPERATION = Feasibility |
| | | | check performed, and update operation is done based on result of |
| | | | feasibility check. |
| reserveResources | Boolean | 0 . . . 1 | Set to “True” if resource reservation must be done. The resource is marked |
| | | | reserved based on the Timestamp value set in updateTime attribute. |
| | | | Set to “FALSE” if resource reservation is not needed. |

Notes to table 3:
When only feasibility check is required for the operation, or when no feasibility check is required, the reserveResources attribute shall be ignored.
When there is no updateTime indicated, i.e. immediate update, the reserveResources attribute shall be ignored.

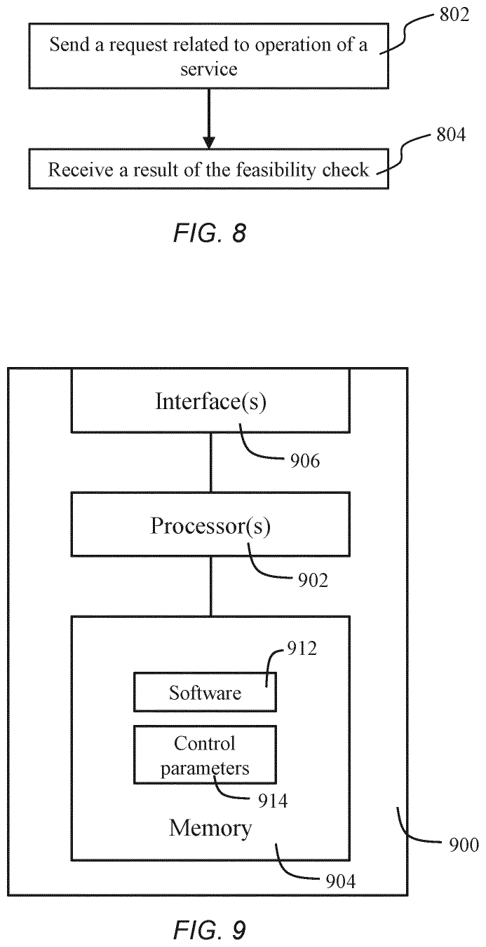

FIG. 9 illustrates one embodiment of a first network element, 900, for implementing an orchestrator, which implements embodiments of the method described earlier. The first network element, 900, comprises a processing circuitry, 902, and a memory, 904. The memory, 904, contains instructions executable by the processing circuitry, 902, such that the first network element, 900, is operative to receive a request related to operation of a service, the request comprising a first attribute instructing the orchestrator to perform a feasibility check for the service identified in said request. The first network element, 900, is further operative to perform the feasibility check for the service and respond to the request based on the result of the feasibility check.

The first network element, 900, is further operative to perform the operations of the method described in the embodiments disclosed earlier.

The first network element, 900, may include a processing circuitry (one or more than one processor), 902, coupled to an interface, 906, and to the memory 904. The first network element, 900, may comprise more than one interface. For example, one interface may be for connecting to other network elements, and another interface may be provided for the network operator to perform management operations on the first network element, 900. For simplicity and brevity only one interface, 906, has been illustrated in FIG. 9 to represent the possible plurality of interfaces. By way of example, the interface 906, the processor(s) 902, and the memory 904 may be connected in series as illustrated in FIG. 9. Alternatively, these components 902, 904 and 906 may be coupled to an internal bus system of the first network element, 900. The memory 904 may include a Read-Only-Memory (ROM), e.g., a flash ROM, a Random Access Memory (RAM), e.g., a Dynamic RAM (DRAM) or Static RAM (SRAM), a mass storage, e.g., a hard disk or solid state disk, or the like. The memory, 904, may include software, 912, and/or control parameters, 914. The memory, 904, may include suitably configured program code to be executed by the processor(s), 902, so as to implement the above-described method.

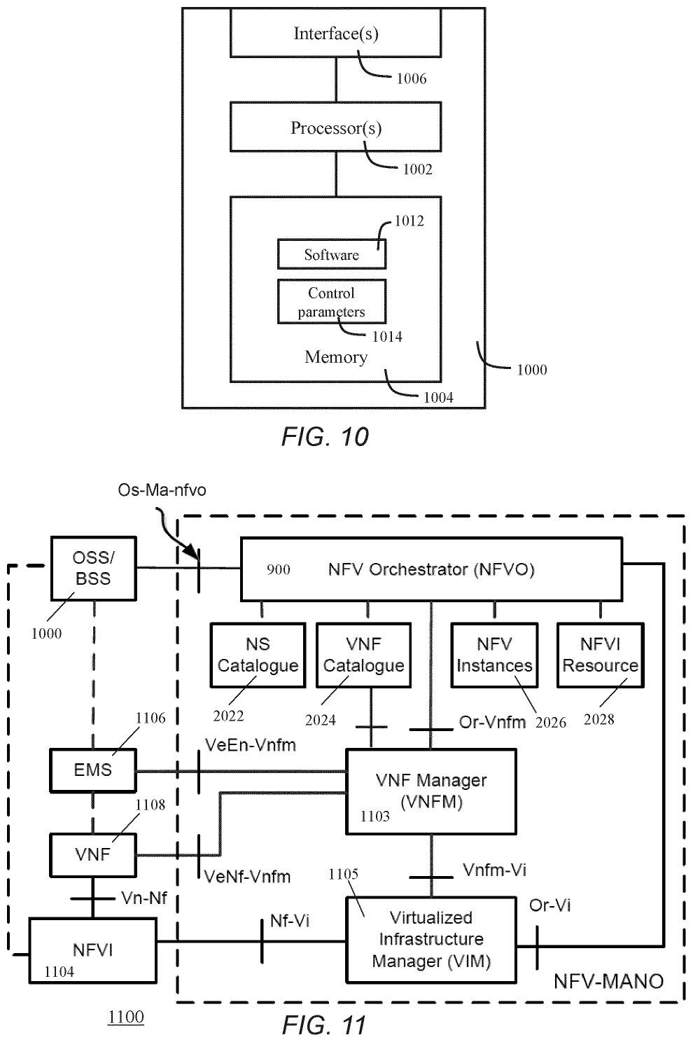

FIG. 10 illustrates an embodiment of a second network element, 1000, for implementing an entity in a virtualised environment of a communications network. The second network element, 1000 may comprise a processing circuitry, 1002, and a memory, 1004. The memory, 1004, contains instructions executable by the processing circuitry, 1002, such that the second network element, 1000, is operative to send to an orchestrator a request related to operation of a service. The request comprises a first attribute instructing the orchestrator to perform a feasibility check for the service identified in said request.

The second network element, 1000, is further operative to perform the operations of the method described in the embodiments disclosed earlier.

The second network element, 1000, may include a processing circuitry (one or more than one processor), 1002, coupled to an interface, 1006, and to the memory 1004. The second network element, 1000, may comprise more than one interface. For example, one interface may be for connecting to other network elements, and another interface may be provided for the network operator to perform management operations on the second network element, 1000. For simplicity and brevity only one interface, 1006, has been illustrated in FIG. 10 to represent the possible plurality of interfaces. By way of example, the interface 1006, the processor(s) 1002, and the memory 1004 may be connected in series as illustrated in FIG. 10. Alternatively, these components 1002, 1004 and 1006 may be coupled to an internal bus system of the first network element, 1000. The memory 1004 may include a Read-Only-Memory (ROM), e.g., a flash ROM, a Random Access Memory (RAM), e.g., a Dynamic RAM (DRAM) or Static RAM (SRAM), a mass storage, e.g., a hard disk or solid state disk, or the like. The memory, 1004, may include software, 1012, and/or control parameters, 1014. The memory, 1004, may include suitably configured program code to be executed by the processor(s), 1002, so as to implement the above-described method.

It is to be understood that the structures as illustrated in FIGS. 9 and 10 are merely schematic and that the first network element, 900, and the second network element, 1000, may actually include further components which, for the sake of clarity, have not been illustrated, e.g., further interfaces or processors. Also, it is to be understood that the memory, 904 and 1004, may include further program code for implementing other and/or known functionalities.

It is also to be understood that the first and second network elements, 900 and 1000, may be provided as a virtual apparatus. In one embodiment, the first and second network elements, 900 and 1000, may be provided in distributed resources, such as in cloud resources. When provided as virtual apparatus, it will be appreciated that the memory, 904, 1004, processing circuitry, 902, 1002, and interface(s), 906, 1006, may be provided as functional elements. The functional elements may be distributed in a logical network and not necessarily be directly physically connected. It is also to be understood that the first and second network elements, 900 and 1000, may be provided as single-node devices, or as a multi-node system.

FIG. 11 illustrates one embodiment of a network, 1100, comprising a first network element, 900, and a second network element, 1000, disclosed earlier. The first network element, 900, is operative to perform the method disclosed for an orchestrator, 900, and the second network element is operative to perform the method disclosed as operating on a second network element.

FIG. 11 shows a schematic view of other entities involved in an example of management of Virtualised Network Functions (VNFs) and their relationships with VNF Manager 1103. The VNF Manager 1103 is one part of an NFV Management and Operations system, NFV MANO and is responsible for VNF life-cycle management. Specifically, the VNF Management functions responsible for the VNF's lifecycle management include:
instantiating VNF, i.e. create a VNF using the VNF on-boarding artefacts;
VNF scaling, i.e. increasing or reducing the capacity of the VNF;
updating and/or upgrading VNF;
terminating VNF, this involves releasing VNF-associated NFVI resources; and
returning them to NFVI resource pool.

The VNF Manager, 1103, can be configured to carry out allocation of instances of Virtualised Network Function Components, VNFCs, to hosts. The allocation may be prompted based on a request received from an OSS/BSS 1000, or from another part of the NFV MANO system. The OSS/BSS, 1000, can be a conventional operational support system and business support system. Coupled to the OSS/BSS, 1000, there is an Element Management System, EMS, 1106. This manages elements used in carrying the traffic across the network and makes use of a number of Virtualised Network Functions 1108. The Virtualised Network Functions (VNF) may make use of Network Functions Virtualization Infrastructure, NFVI, 1104. The NFVI can have virtual compute parts, virtual storage parts and virtual network parts and a virtualization layer, on physical computer hardware, physical storage hardware and physical network hardware. The NFV MANO system further comprises an NFV Orchestrator, NFVO, 900, one or more VNF Managers 1103 and a Virtualized Infrastructure Manager, VIM, 1105 coupled to the VNF Manager, 1103.

The methods of the present disclosure may be implemented in hardware, or as software modules running on one or more processors. The methods may also be carried out according to the instructions of a computer program, and the present disclosure also provides a computer readable medium having stored thereon a program for carrying out any of the methods described herein. A computer program embodying the disclosure may be stored on a computer readable medium, or it could, for example, be in the form of a signal such as a downloadable data signal provided from an Internet website, or it could be in any other form. Some embodiments may be represented as a non-transitory software product stored in a machine-readable medium (also called a computer-readable medium, a processor-readable medium, or a computer usable medium having a computer-readable program code embodied therein). The machine-readable medium may be any suitable tangible medium including a magnetic, optical, or electrical storage medium including a diskette, compact disk read only memory (CD-ROM), digital versatile disc read only memory (DVD-ROM) memory device (volatile or non-volatile), or similar storage mechanism. The machine-readable medium may contain various sets of instructions, code sequences, configuration information, or other data, which, when executed, cause a processor to perform steps in a method according to one or more of the described embodiments. Those of ordinary skill in the art will appreciate that other instructions and operations necessary to implement the described embodiments may also be stored on the machine-readable medium. Software running from the machine-readable medium may interface with circuitry to perform the described tasks.

It should be noted that the above-mentioned examples illustrate rather than limit the disclosure, and that those skilled in the art will be able to design many alternative embodiments without departing from the scope of this document. The word “comprising” does not exclude the presence of elements or steps other than those mentioned in description of embodiments, “a” or “an” does not exclude a plurality, and a single processor or other unit may fulfil the functions of several units recited in this document.

### ABBREVIATIONS

MSCS Multi-site Connectivity Service
NFVO Network Functions Virtualization Orchestrator
VNF Virtualized Network Function
VL Virtual Link
NS Network Service
E2E End to End
NFV Network Function Virtualization
VNFM Virtualized Network Functions Manager
MANO Management and Orchestration
ETSI European Telecommunications Standards Institute
OSS Operation Support System
BSS Business Support System
VIM Virtualized Infrastructure Manager

### REFERENCES

ETSI GS NFV-SOL005 v.3.3.1
ETSI GS NFV-IFA013 v.3.4.1
ETSI GS NFV-IFA005 v.3.4.1
ETSI GS NFV-IFA032 v.3.3.2

1. A method at an orchestrator in a virtualised environment of a communications network, the method comprising:
receiving a request related to operation of a service, the request comprising a first attribute instructing the orchestrator to perform a feasibility check for the service identified in said request;
performing the feasibility check for the service;
responding to the request based on the result of the feasibility check.

2. The method according to claim 1, wherein said request related to operation of the service comprises a second attribute instructing the orchestrator to perform reservation of resources required for the service identified in said request.

3. The method according to claim 1, wherein said feasibility check is performed for constituent network services of said service.

4. The method according to claim 2, wherein said reservation starts at time specified in said request related to operation of the service.

5. The method according to claim 1, wherein responding to said request related to operation of the service comprises sending a result of the feasibility check to an entity from which said request related to operation of the service was received.

6. The method according to claim 1, wherein responding to said request related to operation of the service comprises performing the operation identified in said request if said feasibility check resulted in a pass.

7-8. (canceled)

9. The method according to claim 2, wherein responding to said request related to operation of the service comprises performing reservation of resources required for the service identified in said request and scheduling execution of the operation identified in said request if said feasibility check resulted in a pass.

10. (canceled)

11. The method according to claim 1, wherein the feasibility check for the service identified in said request fails if at least one of the constituent network services of said service fails the feasibility check.

12-13. (canceled)

14. The method according to claim 1, wherein said orchestrator comprises a Network Functions Virtualization Orchestrator.

15-29. (canceled)

30. A nontransitory computer readable medium having stored thereon a computer program that, when executed by one or more processors of an orchestrator in a virtualized environment of a communications network, causes the orchestrator to perform a method that comprises:
receiving a request related to operation of a service, the request comprising a first attribute instructing the orchestrator to perform a feasibility check for the service identified in said request;
performing the feasibility check for the service;
responding to the request based on the result of the feasibility check.

31. A first network element for implementing an orchestrator, the first network element comprising a processing circuitry and a memory, the memory containing instructions executable by the processing circuitry such that the first network element is operative to:
receive a request related to operation of a service, the request comprising a first attribute instructing the orchestrator to perform a feasibility check for the service identified in said request;
perform the feasibility check for the service;
respond to the request based on the result of the feasibility check.

32. The first network element according to claim 31, wherein said request related to operation of the service comprises a second attribute instructing the orchestrator to perform reservation of resources required for the service identified in said request.

33. The first network element according to claim 31, operative to perform said feasibility check for constituent network services of said service.

34. The first network element according to claim 32, wherein said reservation starts at time specified in said request related to operation of the service.

35. The first network element according to claim 31, wherein in responding to said request related to operation of the service the first network element is operative to send a result of the feasibility check to an entity from which said request related to operation of the service was received.

36. The first network element according to claim 31, wherein in responding to said request related to operation of the service the first network element is operative to perform the operation identified in said request if said feasibility check resulted in a pass.

37-38. (canceled)

39. The first network element according to claim 32, wherein in responding to said request related to operation of the service the network element is operative to perform reservation of resources required for the service identified said request and schedule execution of the operation identified in said request if said feasibility check resulted in a pass.

40. (canceled)

41. The first network element according to claim 31, wherein the feasibility check for the service identified in said request fails if at least one of the constituent network services of said service fails the feasibility check.

42. The first network element according to claim 31, wherein said request related to operation of the service comprises a request to instantiate the service.

43. The first network element according to claim 31, wherein said request related to operation of the service comprises a request to update the service.

44. The first network element according to claim 31, wherein said orchestrator comprises a Network Functions Virtualization Orchestrator.

45-57. (canceled)

58. A network comprising:
a first network element according to claim 31; and
a second network element for implementing an entity in the virtualized environment of the communications network, wherein the second network element comprises a processing circuitry and a memory, the memory containing instructions executable by the processing circuitry such that the second network element is operative to:
send to the orchestrator the request related to operation of the service, the request comprising the first attribute instructing the orchestrator to perform the feasibility check for the service identified in said request.
